(19) United States
(12) Patent Application Publication
(10) Pub. No.: US 2026/0250075 A1
(43) Pub. Date: Aug. 27, 2026

(54) MOTOR MOUNTING ASSEMBLY AND METHOD OF USE

(71) Applicant: The Overly Hautz Motor Base Company, Lebanon, OH (US)

(72) Inventor: Thomas Copanas, Mason, OH (US)

(21) Appl. No.: 19/549,450

(22) Filed: Feb. 25, 2026

Related U.S. Application Data
(60) Provisional application No. 63/763,036, filed on Feb. 25, 2025.

(51) Int. Cl. B65G 23/22; B65G 23/24; F16H 7/14; F16H 7/08

(52) U.S. Cl. CPC B65G 23/22; B65G 23/24; F16H 7/14; F16H 2007/0806; F16H 2007/0865; F16H 2007/0893; F16H 2007/0895

(57) ABSTRACT

A motor mounting assembly for supporting a motor is disclosed. The motor mounting assembly comprises a spring reactive pivot base having a top portion, a base portion, and at least one spring; and a shaft mounted gearbox operatively coupled to the base portion. The input shaft of the shaft mounted gearbox is configured to be operatively coupled to the motor through a mechanical coupling. The input shaft is configured to turn at a first rotational speed and the output shaft is configured to turn at a second rotational speed that is different from the first rotational speed of the input shaft. A method of using a motor mounting assembly to operate a mechanical system is also disclosed.

### CROSS-REFERENCE TO RELATED APPLICATION

This application claims the benefit of priority to U.S. Provisional Patent Application Serial No. 63/763,036, filed February 25, 2025, the disclosure of which is incorporated by reference herein in its entirety.

### TECHNICAL FIELD

The present disclosure relates generally to motors and, more specifically, to a mounting assembly for supporting a motor.

### BACKGROUND

Motors, such as electric motors, are widely used for driving fans, conveyors, tools, and other mechanical devices. Generally, motors generate mechanical power at a rotatable output shaft that transmits through at least one mechanical coupling and ultimately to a mechanically driven device. For example, one end of a belt, or a similar coupling, may be wrapped about a drive pulley on the output shaft and another end of the belt may be wrapped about a driven pulley operatively connected to a fan or another device. In turn, the belt effectively and efficiently transfers torque from the drive pulley to the driven pulley. Of course, any number of motors, mechanical couplings, and mechanical devices may be operatively connected in a mechanical system for producing simple to relatively complex machines, such as those used in industrial applications.

Proper positioning of the motor relative to the remainder of the mechanical system is important to ensure that power is transmitted through the mechanical coupling smoothly, consistently, and without creating unnecessary damage to the mechanical system. For example, even small changes in distance or alignment between the drive pulley and the driven pulley may cause power transmission to significantly fluctuate or generate mechanical wear that also reduces efficiency of the overall mechanical system. In industrial settings often requiring high power outputs, this damage and reduced efficiency can equate to significant financial loss.

In addition, workloads on the driven device may fluctuate resulting in extra tension during the transmission of power. For example, extra tension may occur during start up and with a surge of work. The extra tension shortens the lifecycle of drive components such as belts, pulleys, and bearings, for example. Fixed-position motor mounts have limited ability to respond to changing workloads and, therefore, limited ability to reduce the extra tension when it occurs. A fixed mount relies on belts to minimize increased tension in contrast to the response from a reactive pivot base that reduces belt tension and wear on belts, pulleys, and bearings.

A motor may be mounted to a motor mounting assembly having one or more adjustable fixtures that provide for simple adjustments to the position and alignment of the motor. However, conventional adjustable fixtures leave much to be desired. Thus, there is a need for a motor mounting assembly for supporting a motor that addresses present drawbacks and shortcomings of known motor mounting assemblies. To that end, it would be desirable to provide an improved motor mounting assembly for supporting a motor. It would also be desirable to provide an improved motor mounting assembly to minimize extra tension in a drive belt such as during start up and with a surge of work.

### SUMMARY

In one set of embodiments of the disclosure, a motor mounting assembly for supporting a motor is disclosed. The motor mounting assembly includes a spring reactive pivot base having a top portion and a base portion, a motor operatively coupled to the top portion, and a shaft mounted gearbox operatively coupled to the base portion. The base portion of the spring reactive pivot base is pivotably coupled to the top portion and at least one spring operatively coupled to the top portion and the base portion to bias the top portion away from the base portion. The shaft mounted gearbox includes an input shaft and an output shaft, wherein the motor is operatively coupled to the input shaft of the shaft mounted gearbox through a mechanical coupling to turn the input shaft at a first rotational speed, and wherein the shaft mounted gearbox is configured to rotate the output shaft at a second rotational speed that is different from the first rotational speed of the input shaft.

In one embodiment, the mechanical coupling includes a drive pulley and a driven pulley connected together with at least one belt. In another embodiment, the motor includes at least one foot, the at least one foot releasably coupling the motor to the top portion of the of the spring reactive pivot base.

In another embodiment, the first rotational speed of the input shaft is in the range of 15-25 times faster than the second rotational speed of the output shaft. In yet another embodiment, the first rotational speed of the input shaft is approximately 15 times faster than the second rotational speed of the output shaft.

In one embodiment, the at least one spring includes a first spring and a second spring, each separately coupled to the top portion and the base portion to bias the top portion away from the base portion. In another embodiment, the top portion and the base portion are coupled by a pivot shaft such that the top portion pivots about the pivot shaft relative to the base portion. In another embodiment, the top portion and the base portion further include a plurality of holes and a plurality of slots for securing the motor to the spring reactive pivot base and to properly align the motor with the input shaft of the shaft mounted gearbox.

In one embodiment, the base portion further includes a support shaft arranged substantially parallel to the pivot shaft, a first end of a spring shaft is coupled to the support shaft and a second end of the spring shaft is coupled to the top portion, the at least one spring being mounted along the spring shaft between the support shaft and a lower surface of the top portion.

In a further embodiment, an adjuster engages the second end of the spring shaft, the adjuster configured to adjust a length of the spring so as to change a bias force between the top portion and the base portion. In another embodiment, the combination of the at least one spring and the pivot shaft allow for the motor secured to the spring reactive pivot base to move relative to the input shaft of the shaft mounted gearbox as necessary according to a workload of the motor.

In another aspect of the disclosure, a method of using a motor mounting assembly to operate a mechanical system is disclosed. The method includes providing a motor mounting assembly including a spring reactive pivot base having a top portion and a base portion pivotably coupled to the top portion and at least one spring operatively coupled to the top portion and the base portion to bias the top portion away from the base portion; a motor operatively coupled to the top portion; and a shaft mounted gearbox operatively coupled to the base portion, the shaft mounted gearbox having an input shaft and an output shaft, the shaft mounted gearbox configured to rotate the output shaft at a output rotational speed based on an input rotational speed of the input shaft, wherein the motor is operatively coupled to the input shaft of the shaft mounted gearbox through a mechanical coupling; coupling the output shaft to a rotatably mounted component of the mechanical system; and operating the motor so as to turn the input shaft at the input rotational speed and the output shaft at the output rotational speed so as to rotate the rotatably mounted component of the mechanical system.

In one embodiment, the method includes providing a mechanical coupling, mechanical coupling including a drive pulley operatively connected to the motor and a driven pulley operatively connected to the input shaft and a belt connecting the drive pulley to the driven pulley. In another embodiment, the method further comprises aligning the drive pulley with the driven pulley prior to the coupling of the output shaft.

In one embodiment, the method includes providing an input rotational speed of the input shaft that is in the range of 15-25 times faster than the output rotational speed of the output shaft. In another embodiment, the method includes providing an input rotational speed of the input shaft that is approximately 15 times faster than the output rotational speed of the output shaft.

In yet another embodiment, the rotatably mounted component is a shaft operatively coupled to a conveyor belt. In another embodiment, the method further includes adjusting a tension on the at least one spring so as to change the bias between the top portion and the base portion prior to operating the motor.

It will be understood that the motor mounting assembly and associated method achieves several technical advantages over known methods where conventional adjustable fixtures leave much to be desired. The motor mounting assembly provides an improved motor mounting assembly for supporting a motor, eliminates the need to realign pulleys, and reduces the need to replace belts and practically eliminates the need to re-tension belts. In short, the disclosed reactive motor mounting assembly significantly reduces the labor cost required to maintain the functionality of the equipment and reduces lost production while the equipment is being serviced.

### BRIEF DESCRIPTION OF THE DRAWINGS

The accompanying drawings are included to provide a further understanding of the embodiments of the disclosure and are incorporated in and constitute a part of this specification. The drawings illustrate one or more embodiments, and together with the detailed description serve to explain principles and operation of the various embodiments. Features and attributes associated with any of the embodiments shown or described may be applied to other embodiments shown, described, or appreciated based on this disclosure.

FIG. 1 is a perspective view of a mechanical system including an embodiment of a motor mounting assembly, according to an aspect of the disclosure.

FIG. 2 is a perspective view of the motor mounting assembly of FIG. 1.

FIG. 3 is a front view of the motor mounting assembly of FIG. 1.

FIG. 4 is a right side view of the motor mounting assembly of FIG. 1.

FIG. 5 is a left side view of the motor mounting assembly of FIG. 1.

FIG. 6 is a rear view of the motor mounting assembly of FIG. 1.

FIG. 7 is a top view of the motor mounting assembly of FIG. 1.

FIG. 8 is a bottom view of the motor mounting assembly of FIG. 1.

### DETAILED DESCRIPTION

The exemplary embodiments described herein are provided for illustrative purposes and are not limiting. Other exemplary embodiments are possible, and modifications may be made to the exemplary embodiments within the scope of the present disclosure. Therefore, the description below is not meant to limit the scope of the present disclosure.

In general, the description relates to a motor mounting assembly for supporting a motor. As described above, there are drawbacks or shortcomings of existing motor mounting assemblies. Advantageously, aspects of the motor mounting assembly of the present disclosure, described in greater detail below, address the drawbacks and shortcomings of existing motor mounting assemblies. Particularly, the motor mounting assembly of the present disclosure includes a spring reactive pivot motor base and a shaft mounted gearbox which work in combination to provide significant advantages over existing motor mounting assemblies, as described in greater detail below. Other advantages and technical effects of the embodiments of this disclosure will become evident to one skilled in the art from the following description.

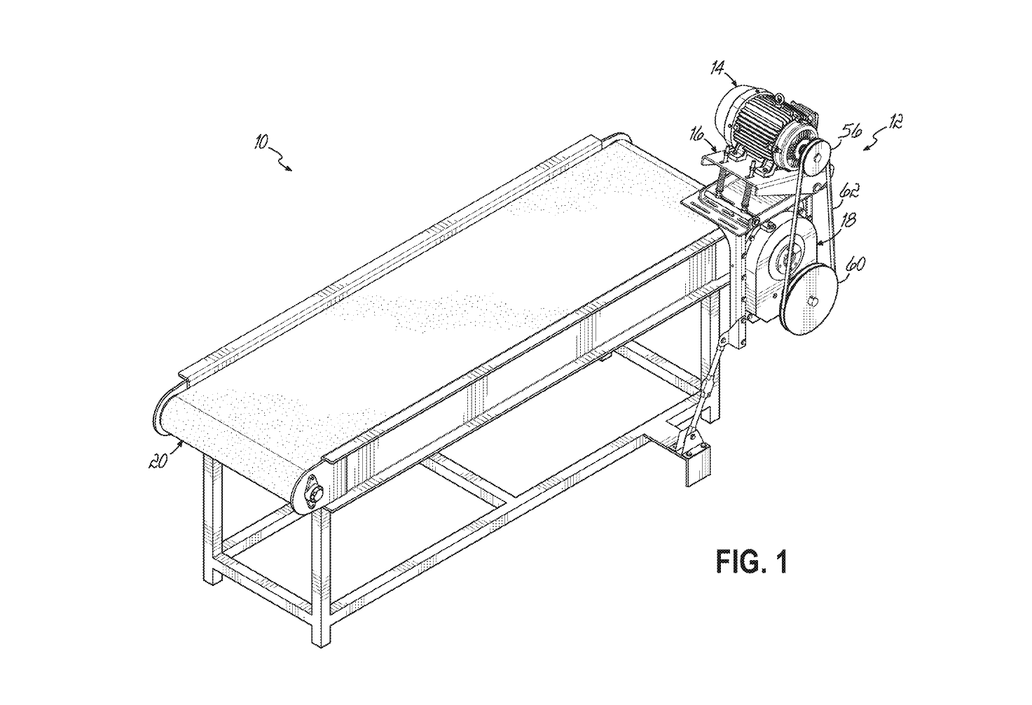

Referring now to FIG. 1, the Figure illustrates an embodiment of a mechanical system 10, according to an aspect of the disclosure. In the depicted embodiment, the mechanical system 10 includes a motor mounting assembly 12. The motor mounting assembly 12 generally includes a motor 14 and a spring reactive pivot base 16. The motor 14 is mounted to the spring reactive pivot base 16. The motor mounting assembly 12 further includes a shaft mounted gearbox 18. The motor 14 is operatively connected to the shaft mounted gearbox 18. The shaft mounted gearbox 18 is in turn operatively connected to a conveyor belt 20. Thus, the motor 14 drives the conveyor belt 20, but the output (e.g., RPM) of the motor 14 is reduced by the shaft mounted gearbox 18 such that the output (e.g., RPM) of the shaft mounted gearbox 18 is appropriate to drive the conveyor belt 20.

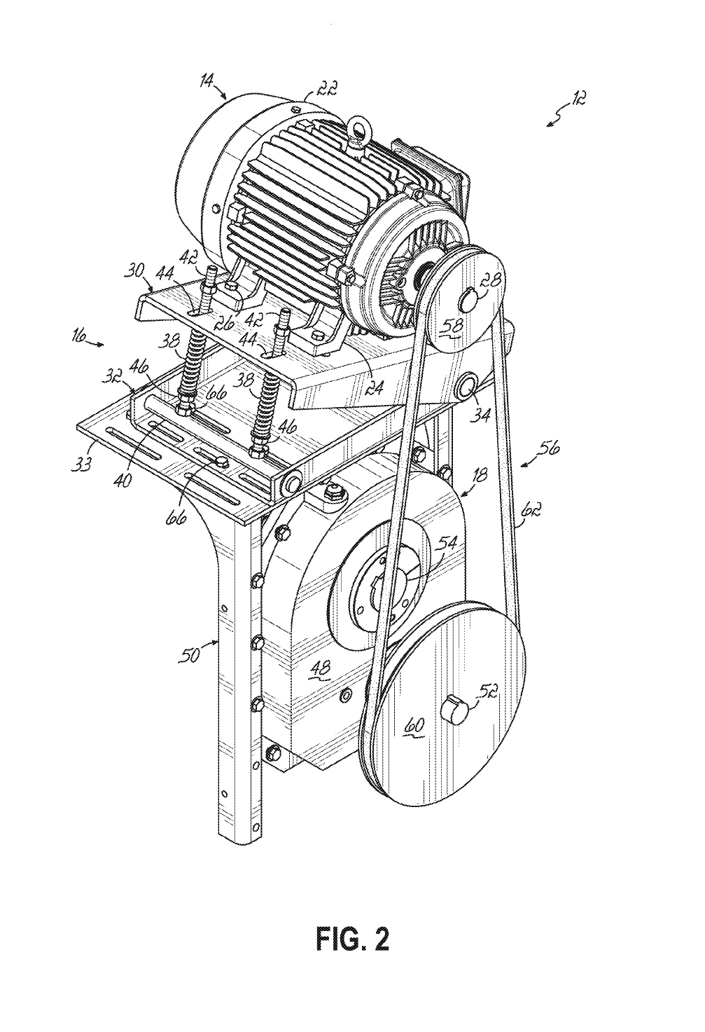

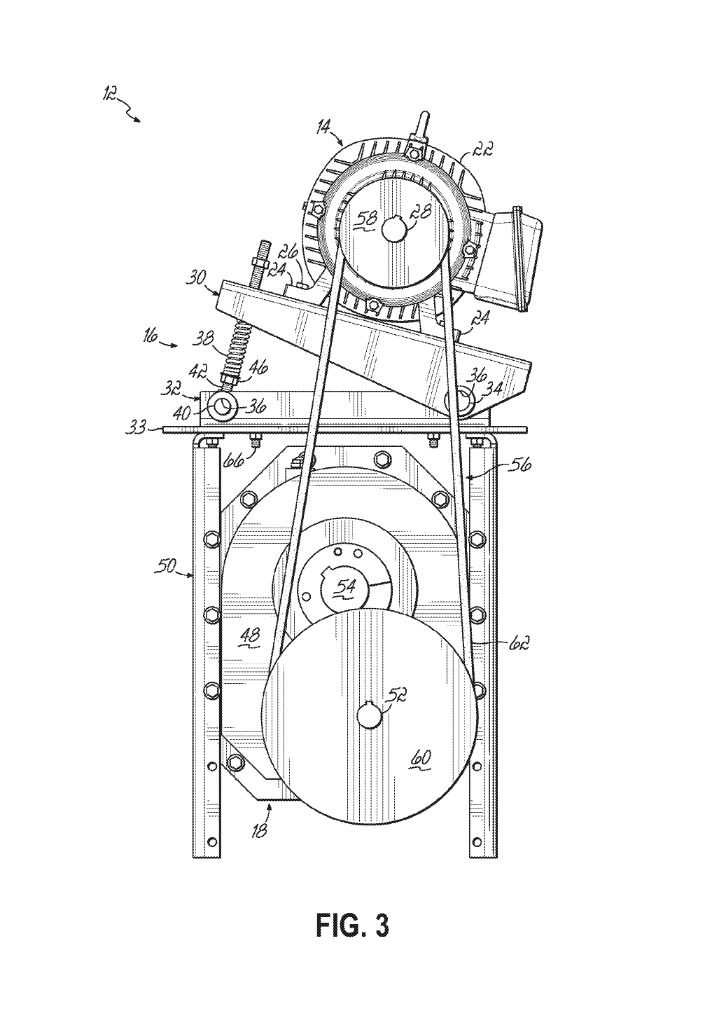

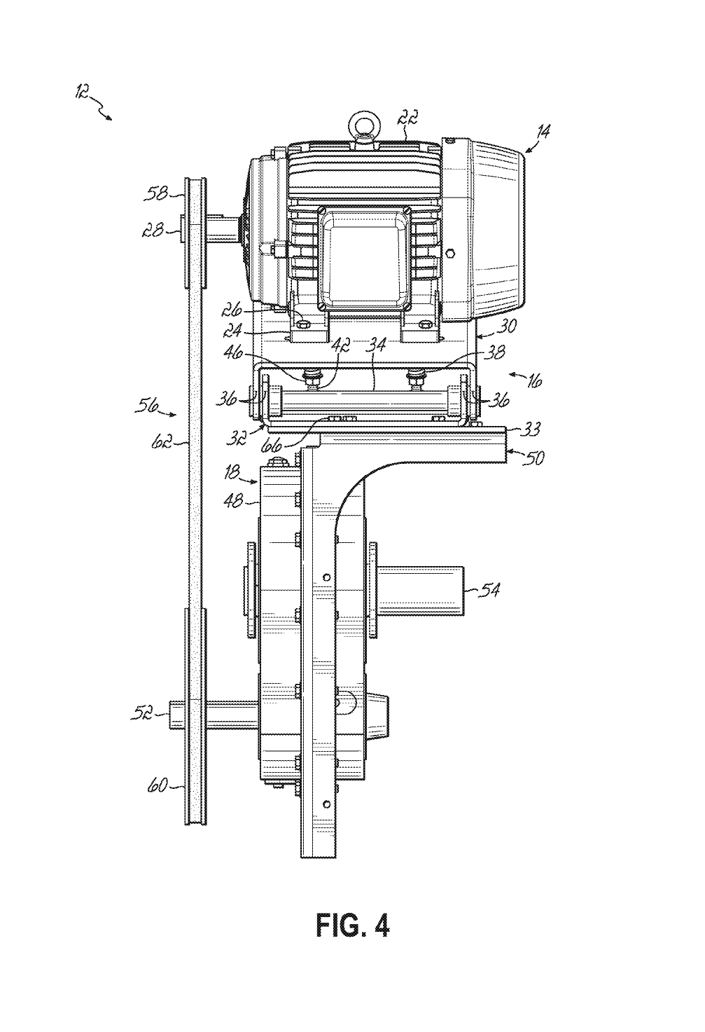

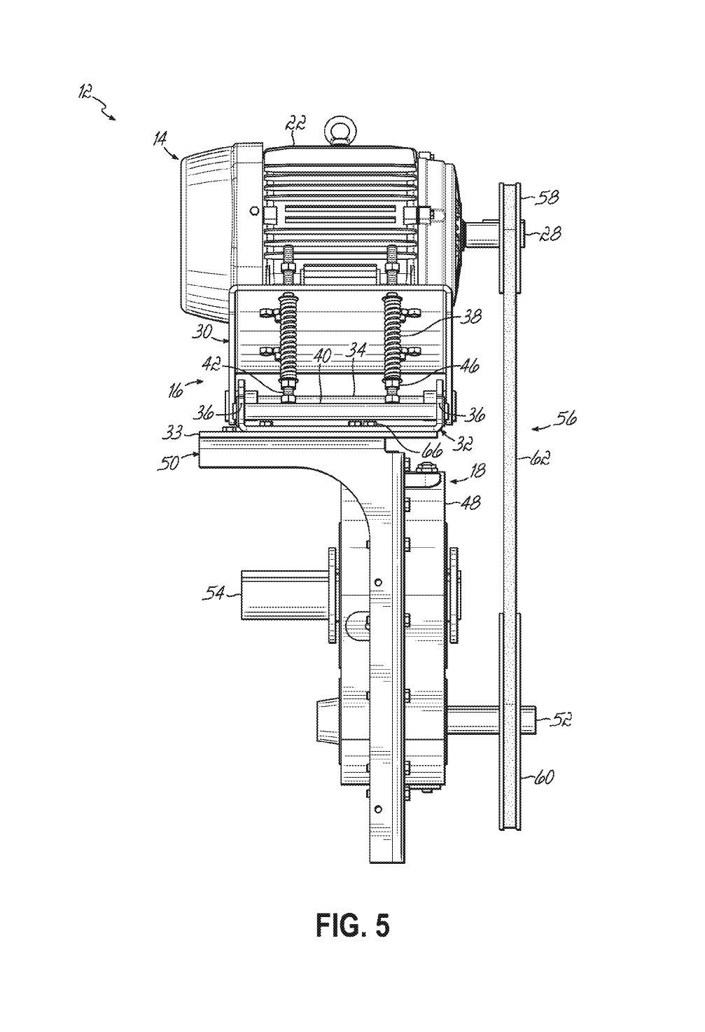

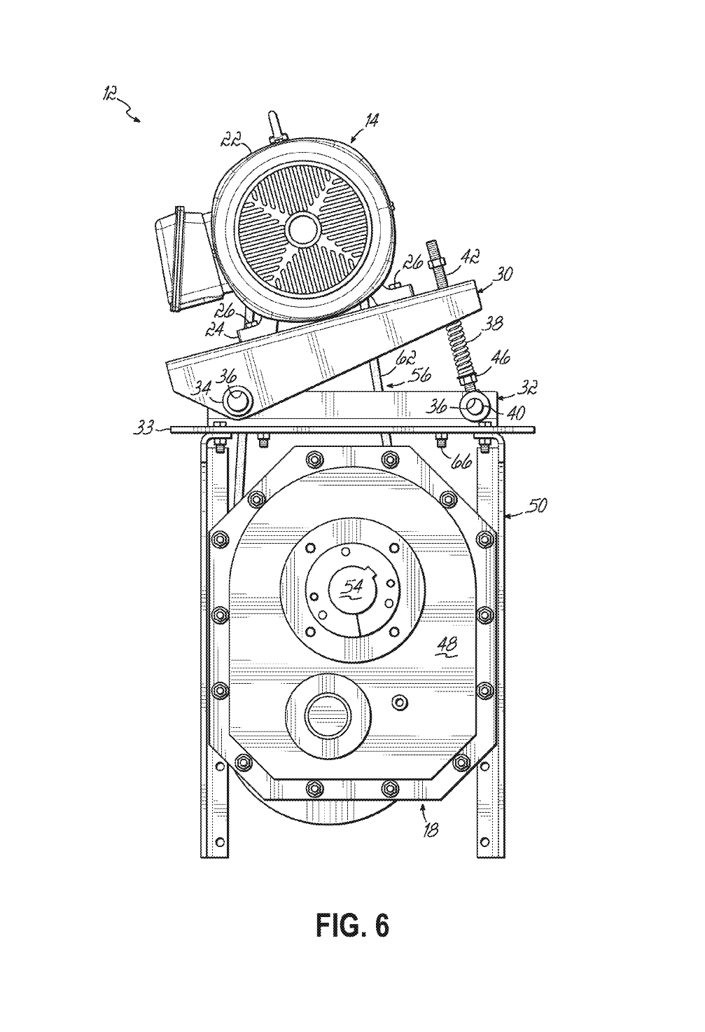

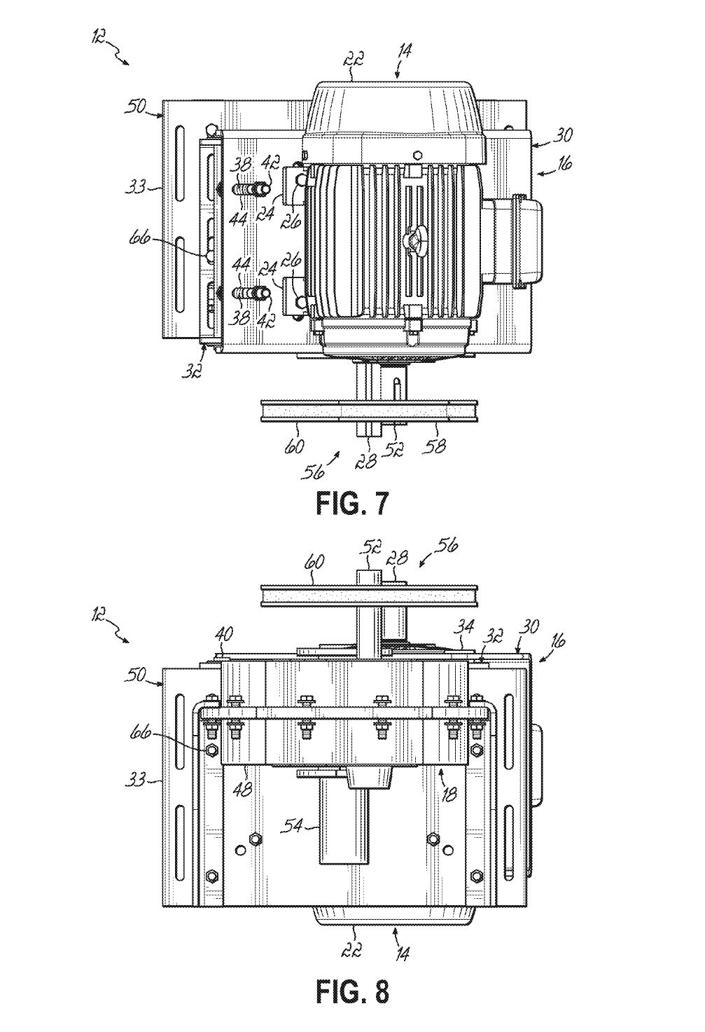

FIGS. 2-8 illustrate various views of an embodiment of the motor mounting assembly 12, according to an aspect of the disclosure. As noted above, the motor mounting assembly 12 includes a motor 14. The motor 14 may be a WEG brand: NEMA Electric Motor, 254 Frame Size, Part Number 01518ET3E254T-W22, RPM 1,800, commercially available from Motion Industries, for example. It should be understood that alternative motors 14 may be used. In the depicted embodiment, the motor 14 includes a motor body 22 and at least one foot 24. The at least one foot 24 of the motor 14 is releasably secured to a portion of the spring reactive pivot base 16 (FIG. 3) by at least one mechanical fastener 26. The mechanical fastener 26 may be a bolt, for example, with or without a corresponding nut or nuts. It should be understood that the motor 14 may be alternatively secured to the spring reactive pivot base 16. The motor 14 further includes at least one rotatable output shaft 28 for transmitting the mechanical power generated by the motor 14.

The motor mounting assembly 12 further includes a spring reactive pivot base 16. The spring reactive pivot base 16 generally includes a top portion 30 and a base portion 32. The spring reactive pivot base 16 may further include a support plate 33 configured to reinforce the stability of the motor mounting assembly 12. The base portion 32 may be secured to the support plate 33 through mechanical fasteners or by other known means. In the depicted embodiment, the top portion 30 and the base portion 32 are made of steel and are substantially planar. It should be understood that the top portion 30 and the base portion 32 of the spring reactive pivot base 16 could be made of an alternative material and/or take on alternative forms. In the depicted embodiment, the motor 14 is releasably secured to the top portion 30 of the spring reactive pivot base 16. It should be understood that the motor 14 could be alternatively arranged relative to the spring reactive pivot base 16. The rotational direction of the driven device and the motor 14 will determine the mounting position of the spring reactive pivot base 16. The spring side of the spring reactive pivot base 16 should be positioned on the tight belt side. The top portion 30 and the base portion 32 of the spring reactive pivot base 16 are joined by a pivot shaft 34 such that the top portion 30 pivots about the pivot shaft 34 relative to the base portion 32. In the depicted embodiment, both the top portion 30 and the base portion 32 include apertures 36 (FIG. 3) through which the pivot shaft 34 extends to facilitate the pivoting movement. It should be understood that the top portion 30 and the base portion 32 of the spring reactive pivot base 16 may be alternatively joined while still allowing pivoting movement. Both the top and base portions 30, 32 may have holes and slots for mounting and adjusting the motor 14 and the spring reactive pivot base 16 to properly align the motor 14 with the shaft mounted gearbox 18.

With continued reference to FIGS. 2-8, the spring reactive pivot base 16 further includes at least one spring 38 which facilitates reactive movement of the motor 14. The spring reactive pivot base 16 becomes reactive because it is responding to changing workloads on the driven device. More specifically, in the depicted embodiment, the base portion 32 of the spring reactive pivot base 16 includes a support shaft 40 arranged substantially parallel to the base portion 32 from which at least one spring shaft 42 extends in a direction substantially perpendicular to the support shaft 40 towards the top portion 30. A proximal end of the at least one spring shaft 42 is connected to the support shaft 40, while a distal end of the at least one spring shaft 42 is received by and extends through a slot 44 in the top portion 30 of the spring reactive pivot base 16.

The at least one spring 38 is arranged on the at least one spring shaft 42 between the proximal end of the at least one spring shaft 42 and the top portion 30 of the spring reactive pivot base 16 such that the top portion 30 may rest on top of the at least one spring 38. The combination of the at least one spring 38 and pivot shaft 34 allow for the motor 14 mounted to the spring reactive pivot base 16 to move (e.g., up and down) as necessary according to the workload of the motor 14. The relative location of the at least one spring 38 on the at least one spring shaft 42 is adjustable. For example, in the depicted embodiment, a nut 46 on the at least one spring shaft 42 (and thus the at least one spring 38) may be moved (e.g., up or down on the spring shaft 42) to adjust the belt tension of the belt 62. It should be understood that the at least one spring 38 may be alternatively arranged while still allowing for the described belt tension. The at least one spring 38 may be selected to provide a desired belt tension of belt 62. A user may select a spring 38 or combination of springs 38 with a particular spring constant, k, or other property to achieve a desired belt tension of belt 62. For example, the spring 38 may be a Danly Heavy Duty Spring with part number 9-2016-26. That particular spring fulfills the requirements of the spring reactive pivot base 16, the motor 14, and the shaft mounted gearbox 18. The spring 38 is available from Misumi.

With continued reference to FIGS. 2-8, the motor mounting assembly 12 further includes a shaft mounted gearbox 18. The shaft mounted gearbox 18 may be a Dodge brand: Shaft Mount Speed Reducer, Reducer Size TXT615T, Part Number E246150, 15:1 speed reduction, commercially available from Motion Industries, for example. It should be understood that alternative shaft mounted gearboxes may be used, such as Dodge TA gearbox, for example. In the depicted embodiment, the shaft mounted gearbox 18 includes a gearbox body 48. The gearbox body 48 may be releasably secured to the support plate 33 of the spring reactive pivot base 16 by a gearbox mount 50 and at least one mechanical fastener 66. Alternatively, the gearbox body 48 may be releasably secured to the base portion 32 by the gearbox mount 50 and at least one mechanical fastener 66. The mechanical fastener 66 may be a bolt, for example, with or without a corresponding nut or nuts. It should be understood that the shaft mounted gearbox 18 may be alternatively secured to the spring reactive pivot base 16. Further, it should be understood that the shaft mounted gearbox 18 may be alternatively arranged relative to the spring reactive pivot base 16. For example, the shaft mounted gearbox 18 may be mounted horizontally instead of vertically.

The shaft mounted gearbox 18 further includes at least one rotatable input shaft 52 and one rotatable output shaft 54. The shaft mounted gearbox 18 accepts the transmitted mechanical power from the motor 14 via the input shaft 52. More specifically, mechanical power is transmitted from the motor 14 to the shaft mounted gearbox 18 by a mechanical coupling 56. In the depicted embodiment, the mechanical coupling 56 includes at least one drive pulley 58 and at least one driven pulley 60 connected by at least one belt 62. The spring 38 or combination of springs 38 of the spring reactive pivot base 16 may be selected to achieve or maintain a particular tension in the at least one belt 62 with a particular motor 14 mounted on the spring reactive pivot base 16. It should be understood that alternative mechanical couplings 56 may be used. After receiving the mechanical power from the motor 14, the shaft mounted gearbox 18 converts the high-speed, low-torque mechanical power input from the motor 14 into a low-speed, high-torque mechanical power output. (e.g., through the use of a gear arrangement within the shaft mounted gearbox 18). The shaft mounted gearbox 18 then further transmits the mechanical power via the output shaft 54. For example, the input shaft 52 of the shaft mounted gearbox 18 may have an RPM of 1800, and the shaft mounted gearbox 18 may then reduce the rotational speed of the input such that the output shaft 54 has an RPM of 120—appropriate to drive the conveyor belt 20. This example is for a 15:1 speed reduction, but other speed reductions may be used such as a 25:1 speed reduction. In the depicted embodiment, the output shaft 54 of the shaft mounted gearbox 18 then communicates that stepped down mechanical power to the conveyor belt 20 (FIG. 1).

Referring generally to FIGS. 1-8, the motor mounting assembly 12 including the spring reactive pivot base 16 and the shaft mounted gearbox 18, as described in the embodiments above and as shown in the Figures, achieves significant benefits over all known nonreactive fixed position motor mounting assemblies. One benefit of the spring reactive pivot base 16 and the shaft mounted gearbox 18 is the curtailment of time-consuming procedures to realign pulleys and tighten belts. With all known nonreactive fixed position mounting assemblies, adjusting or replacing the belt, for example, that transfers energy between the motor and shaft mounted gearbox requires realignment of the motor and shaft mounted gearbox. Such is not true with the inclusion of the spring reactive pivot base 16. The inclusion of the spring reactive pivot base 16 eliminates the need to realign pulleys, reduces the need to replace belts and practically eliminates the need to re-tension belts. In short, the disclosed reactive motor mounting assembly 12 significantly reduces the labor cost required to maintain the functionality of the equipment and reduces lost production while the equipment is being serviced.

A further benefit of the combination of the spring reactive pivot base 16 and the shaft mounted gearbox 18 is the extension of the useful life of wear components of the motor mounting assembly 12, such as the at least one belt 62. In typical motor mounting assemblies, the motor is fixed in a nonreactive relationship to the shaft mounted gearbox 18. When under heavy load, wear components (e.g., belts, pulleys, bearings, and so on) of the motor mounting assembly 12 are put under additional stress and thus the useful life of those wear components is shortened. For example, a heavy workload on a known motor mounting assembly can cause a belt to stretch. The belt would then need to be replaced or the motor mounting assembly re-tensioned to accommodate the stretched belt. In contrast, the spring reactive pivot base 16 of the disclosed motor mounting assembly 12 relieves tension in the belt 62, for example, when the motor 14 is under a heavy workload to reduce the likelihood that the belt 62 becomes stretched. Furthermore, even if the belt 62 were to become stretched over time, the spring reactive pivot base 16 can accommodate the stretching of the belt 62 without having to resort to re-tensioning of the motor mounting assembly 12. In short, the disclosed motor mounting assembly 12 provides responsive belt tensioning that significantly extends the useful lifecycle of belts, pulleys, and bearings resulting in substantial time and cost savings.

With continued reference to FIGS. 1-8 generally, a further benefit of the combination of the spring reactive pivot base 16 and the shaft mounted gearbox 18 is more efficient mechanical power delivery resulting in the conservation of energy. Because the at least one spring 38 and pivot shaft 34 of the spring reactive pivot base 16 allow the motor 14 to move as needed while delivering mechanical power, the delivery of the mechanical power is more smooth in comparison to all known nonreactive, fixed motor mounting assemblies. More specifically, the at least one belt 62 runs more smoothly with less slippage and less vibration and thus delivers more power more smoothly to the driven pulley 60. In contrast to all existing alternatives, the motor mounting assembly 12 of this disclosure more efficiently transfers energy from the motor 14 to the driven device resulting in a conservation of energy.

The reactive pivot base 16 delivers four significant advantages over nonreactive, fixed-position, motor mount assemblies: (1) reduces labor expense to maintain equipment functionality; (2) reduces equipment repair and replacement cost by extending the lifecycle of belts, pulleys and bearings; (3) increases production by reducing downtime; and (4) conserves and reduces energy expense by more efficiently delivering power from the electric motor to the driven device.

With reference to FIGS. 1-8, the motor mounting assembly 12 may be used to implement a method of using the motor mounting assembly 12 to operate a mechanical system 10. The method includes coupling the output shaft 54 to a rotatably mounted component of the mechanical system and operating the motor 14 so as to turn the input shaft 52 at an input rotational speed and the output shaft 54 at an output rotational speed so as to rotate the rotatably mounted component of the mechanical system 10. The method may further include operatively coupling the motor 14 to the input shaft 52 of the shaft mounted gearbox 18 through a mechanical coupling 56. The mechanical coupling includes the drive pulley 58 operatively connected to the motor 14 and the driven pulley 60 operatively connected to the input shaft 52 and the belt 62 connecting the drive pulley 58 to the driven pulley 60. The method may further comprise aligning the drive pulley 58 with the driven pulley 60 prior to the coupling of the output shaft 54.

In one embodiment, the method further includes supplying an input rotational speed of the input shaft 52 that is in the range of 15-25 times faster than the output rotational speed of the output shaft 54. In another embodiment, the method further includes supplying an input rotational speed of the input shaft 52 that is approximately 15 times faster than the output rotational speed of the output shaft 54.

In one embodiment, the method further comprises providing a shaft operatively coupled to the conveyor belt 20 as the rotatably mounted component. In another embodiment, the method further comprises adjusting a tension on the at least one spring 38 so as to change the bias between the top portion 30 and the base portion 32 prior to operating the motor 14.

While the present disclosure has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The disclosure in its broader aspects is therefore not limited to the specific details and illustrative examples shown and described. Accordingly, departures may be made from such details without departing from the scope of the general inventive concept.

What is claimed is:

1. A motor mounting assembly for supporting a motor, the mounting assembly comprising:
a spring reactive pivot base having a top portion and a base portion pivotably coupled to the top portion and at least one spring operatively coupled to the top portion and the base portion to bias the top portion away from the base portion, the top portion configured to support a motor; and
a shaft mounted gearbox operatively coupled to the base portion, the shaft mounted gearbox having an input shaft and an output shaft;
wherein the input shaft of the shaft mounted gearbox is configured to be operatively coupled to the motor through a mechanical coupling so as to turn the input shaft at a first rotational speed; and
wherein the shaft mounted gearbox is configured to rotate the output shaft at a second rotational speed that is different from the first rotational speed of the input shaft.

2. The motor mounting assembly of claim 1, wherein the mechanical coupling includes a drive pulley and a driven pulley connected together with at least one belt.

3. The motor mounting assembly of claim 1, further comprising:
a motor operatively coupled to the top portion.

4. The motor mounting assembly of claim 1, wherein the first rotational speed of the input shaft is in a range of 15-25 times faster than the second rotational speed of the output shaft.

5. The motor mounting assembly of claim 4, wherein the first rotational speed of the input shaft is approximately 15 times faster than the second rotational speed of the output shaft.

6. The motor mounting assembly of claim 1, wherein the at least one spring includes a first spring and a second spring, each separately coupled to the top portion and the base portion to bias the top portion away from the base portion.

7. The motor mounting assembly of claim 1, wherein the top portion and the base portion are coupled by a pivot shaft such that the top portion pivots about the pivot shaft relative to the base portion.

8. The motor mounting assembly of claim 1, wherein the top portion and the base portion further include a plurality of holes and a plurality of slots configured to secure the motor to the spring reactive pivot base and to properly align the motor with the input shaft of the shaft mounted gearbox.

9. The motor mounting assembly of claim 7, wherein the base portion further includes a support shaft arranged substantially parallel to the pivot shaft, a first end of a spring shaft is coupled to the support shaft and a second end of the spring shaft is coupled to the top portion, the at least one spring being mounted along the spring shaft between the support shaft and a lower surface of the top portion.

10. The motor mounting assembly of claim 9, wherein an adjuster engages the second end of the spring shaft, the adjuster configured to adjust a length of the at least one spring so as to change a bias force between the top portion and the base portion.

11. The motor mounting assembly of claim 9, wherein a combination of the at least one spring and the pivot shaft is configured to allow the top portion of the spring reactive pivot base to move relative to the input shaft of the shaft mounted gearbox as necessary according to a workload of the motor.

12. A method of using a motor mounting assembly to operate a mechanical system comprising:
providing a motor mounting assembly comprising:
a spring reactive pivot base having a top portion and a base portion pivotably coupled to the top portion and at least one spring operatively coupled to the top portion and the base portion to bias the top portion away from the base portion;
a motor operatively coupled to the top portion; and
a shaft mounted gearbox operatively coupled to the base portion, the shaft mounted gearbox having an input shaft and an output shaft, the shaft mounted gearbox configured to rotate the output shaft at an output rotational speed based on an input rotational speed of the input shaft;
wherein the motor is operatively coupled to the input shaft of the shaft mounted gearbox through a mechanical coupling;
coupling the output shaft to a rotatably mounted component of the mechanical system; and
operating the motor so as to turn the input shaft at the input rotational speed and the output shaft at the output rotational speed so as to rotate the rotatably mounted component of the mechanical system.

13. The method of claim 12, wherein the mechanical coupling includes a drive pulley operatively connected to the motor and a driven pulley operatively connected to the input shaft and a belt connecting the drive pulley to the driven pulley.

14. The method of claim 13, further comprising:
prior to the coupling of the output shaft, aligning the drive pulley with the driven pulley.

15. The method of claim 12, wherein the input rotational speed of the input shaft is in a range of 15-25 times faster than the output rotational speed of the output shaft.

16. The method of claim 15, wherein the input rotational speed of the input shaft is approximately 15 times faster than the output rotational speed of the output shaft.

17. The method of claim 12, wherein the rotatably mounted component is a shaft operatively coupled to a conveyor belt.

18. The method claim 12, further comprising:
prior to operating the motor, adjusting a tension on the at least one spring so as to change the bias between the top portion and the base portion.
